(19) United States
(12) Patent Application Publication
(10) Pub. No.: US 2026/0238149 A1
(43) Pub. Date: Aug. 13, 2026

(54) METHODS AND SYSTEM FOR RESOLVER ERROR CORRECTION

(71) Applicant: Ford Global Technologies, LLC, Dearborn, MI (US)

(72) Inventors: Matthew Penne, Pierce, NE (US); Yang Xu, Canton, MI (US); Jonathan Butcher, Farmington, MI (US); Jonathan Hair, Northville, MI (US)

(21) Appl. No.: 19/052,172

(22) Filed: Feb. 12, 2025

(51) Int. Cl. H02P 21/18; H02P 21/22; H02P 25/022

(52) U.S. Cl. CPC H02P 21/18; H02P 21/22; H02P 25/022

(57) ABSTRACT

Systems and methods for operating an electric drive system for an electric or hybrid vehicle is described. In one example, a rotor position of an electric machine is corrected via an offset value. The offset value may be adjusted according to a speed change of the electric machine during a mode change of the electric machine.

### FIELD

The present description relates to methods and a system for operating an electric machine. The electric machine may include permanent magnets.

### BACKGROUND

Field oriented control is an approach for increasing efficiency and position control of an electric machine (e.g., a permanent magnet motor). An accurate position of the electric machine's rotor and phase of the electric machine's magnetic field may be utilized to control electric current that is supplied to the electric machine. The position of the electric machine's rotor may be determined via a resolver. The resolver may encircle and be mechanically coupled to the electric machine's rotor, or alternatively, a shaft may couple the resolver and the electric machine's rotor. The resolver outputs alternating current waveforms that have amplitudes that vary with the position of the electric machine. In particular, the resolver may include a sine winding output and a cosine winding output. The voltage output of the sine winding is ninety rotational degrees out of phase with the output of the cosine winding. The position of the electric machine may be determined from the amplitude of the sine winding voltage output and the amplitude of the cosine winding voltage output.

The background above is provided to introduce in simplified form a way that electric machine position may be determined. However, it may be appreciated that the background is not intended to constrain the scope of this disclosure. The detailed description provides disclosure that may be applied to increase accuracy of electric machine position determination.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic diagram of a vehicle that includes an electric machine for propulsion;

FIG. 2 shows a plot of a reference frame for controlling an electric machine with rotor offset correction;

FIG. 3 is a schematic diagram of a controller vector reference frame and an electric machine rotor reference frame;

FIG. 4 is a plot showing a comparison between operating an electric machine in MTPA mode and operating the electric machine in lossy mode with electrical degree error;

FIG. 5 is a flowchart of a method for adjusting electric machine rotational position when entering a lossy mode of electric machine operation; and

FIG. 6 is a flowchart of a method for adjusting electric machine rotational position when exiting a lossy mode of electric machine operation.

### DETAILED DESCRIPTION

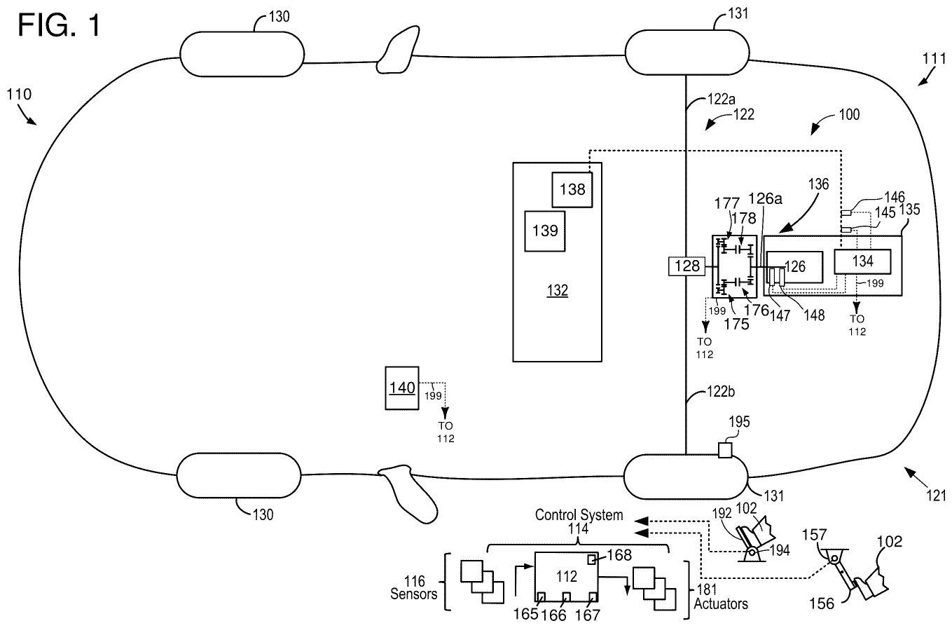

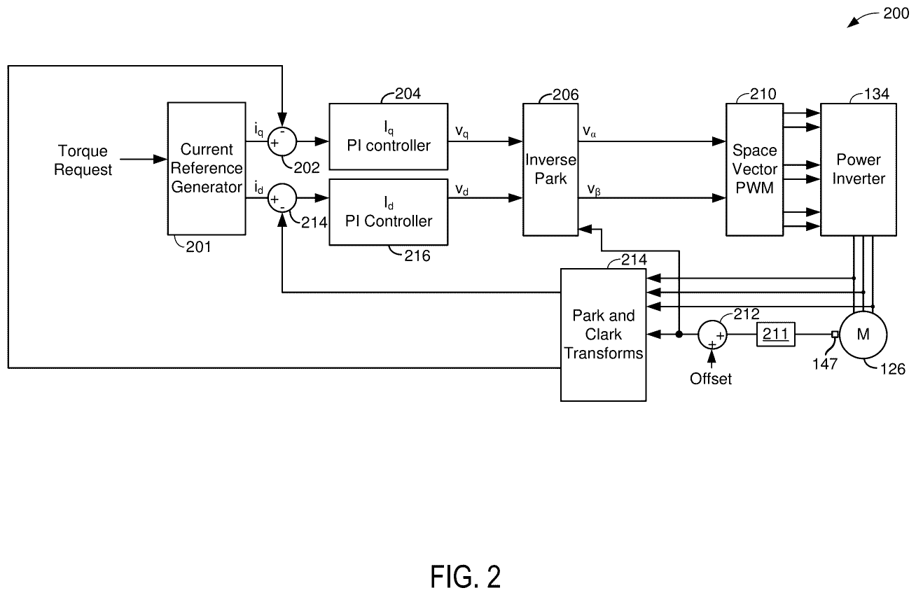

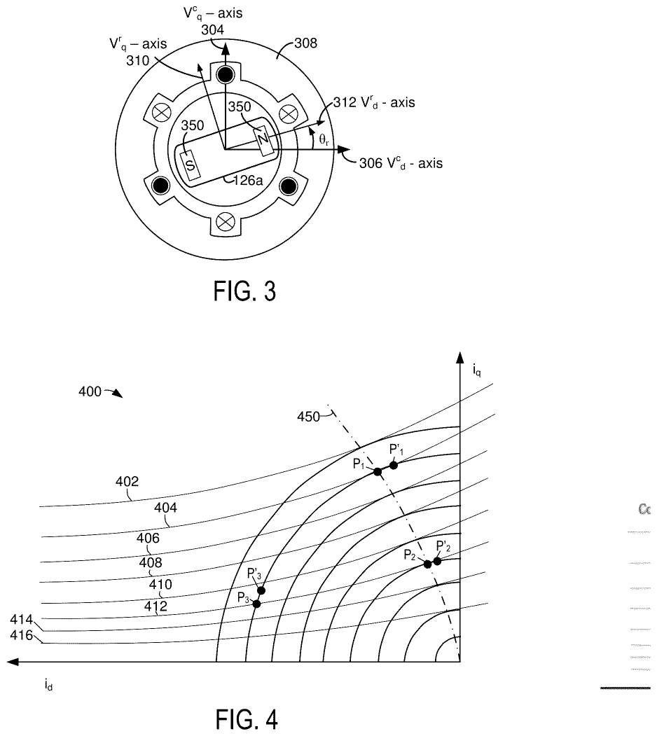

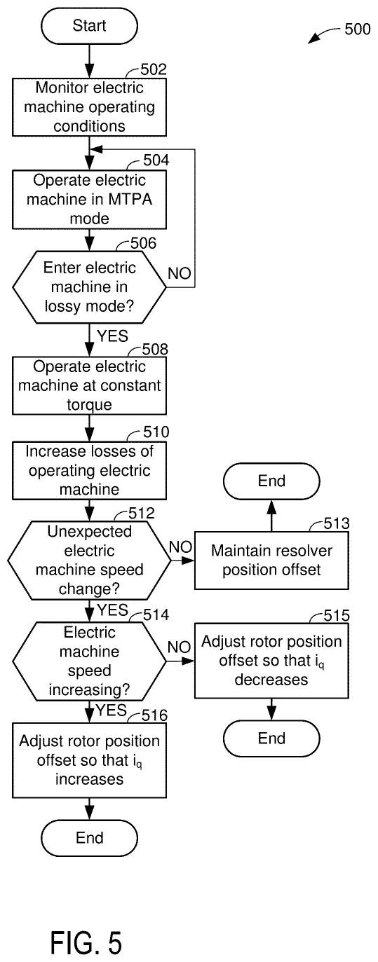

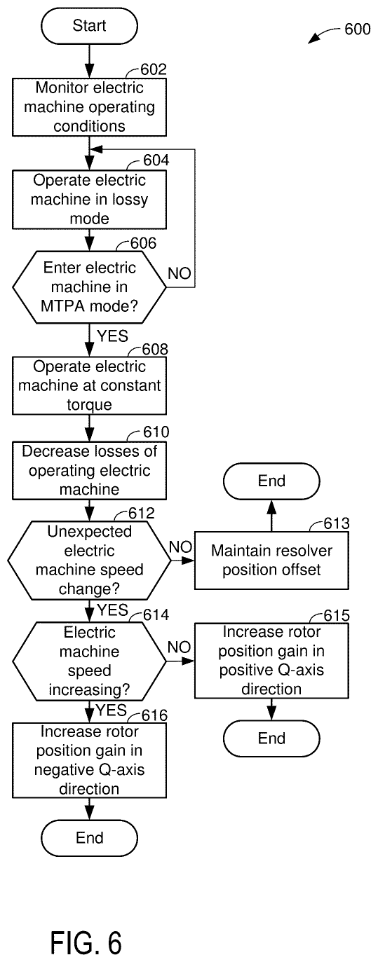

The present description is related to adjusting an electric machine position estimate. The electric machine may be included in a drive system of a vehicle. The methods and systems described herein may permit a more accurate estimate of electric machine position, thereby allowing efficiency and control of the electric machine to increase. In one example, the method includes commanding a space vector pulse width modulated drive to enter a lossy operating mode while operating the electric machine under steady-state conditions. The electric machine position offset value for correcting output of the resolver may be adjusted in response to an unexpected change in electric machine speed. A vehicle that includes a resolver and electric machine is shown in FIG. 1. FIG. 2 shows a block diagram of a space vector pulse width modulated drive system with rotor offset value correction. Two references axes for an electric machine are shown in FIG. 3. An example permanent magnet electric machine is shown in FIG. 4. A block diagram of a first method for estimating the position offset of an electric machine is shown in FIG. 5. A block diagram of a second method for estimating the position offset of an electric machine is shown in FIG. 6.

Electric vehicles and hybrid vehicles include electric drive systems for propulsion. The electric drive systems may include an electric machine that operates in a motor mode or a generator mode. The electric machine may be operated via a control system that may include field oriented control or another type of control. Field oriented control is an approach for increasing efficiency and position control of an electric machine (e.g., a permanent magnet motor). Whether field control or another type of control is provided, it may be desirable to have an accurate position of the electric machine's rotor to feedback the electric machine's rotor position to the controller so that control actions may be performed according to the electric machine's present position. However, it may be possible for the electric machine rotor position sensing device to report a position of the electric machine rotor that may not be as accurate as may be desired due to manufacturing variation or other factors. Therefore, it may be desirable to provide a way of increasing accuracy of determining the position of the electric machine via a position sensing device.

The inventors herein have recognized the above-mentioned issues and have developed a method for operating an electric drive system, comprising: via a controller, operating an electric machine at a first group of conditions with a first amount of losses; transitioning the electric machine to operating at a second group of conditions with a second amount of losses in response to a request to increase electric machine losses, the second amount of losses greater than the first amount of losses; adjusting a rotor position offset value based on a change in a rotational speed of a rotor of the electric machine during transitioning the electric machine from the first group of conditions to the second group of conditions; and adjusting current supplied to the electric machine in response to the rotor position offset value.

By adjusting a rotor position offset value based on a change in a rotational speed of a rotor of an electric machine, it may be possible to increase accuracy of rotor position estimation so that electric machine torque may meet expectations. Further, adjusting the rotor position offset in this way allows the system to make feedback adjustments to the rotor position so that the rotor position estimate may converge to a value.

The present description may provide several advantages. In particular, the approach may provide more accurate estimates of an electric machine position offset. Further, the approach may provide more accurate estimates of electric machine position offset without the expense of additional hardware. In addition, the electric machine position offsets may be generated while a vehicle in which an electric machine provides propulsive torque is operated.

The above advantages and other advantages, and features of the present description will be readily apparent from the following Detailed Description when taken alone or in connection with the accompanying drawings.

The summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not limited to implementations that solve any disadvantages noted above or in any part of this disclosure.

FIG. 1 is a block diagram of a vehicle 121 including a powertrain or driveline 100. A front portion of vehicle 121 is indicated at 110 and a rear portion of vehicle 121 is indicated at 111. Vehicle propulsion system 100 includes electric machine 126. Electric machine 126 may consume or generate electrical power depending on its operating mode. Throughout the FIG. 1, mechanical connections between various components are illustrated as solid lines, whereas electrical connections between various components are illustrated as dashed lines.

Vehicle propulsion system 100 has a rear axle 122. In some examples, rear axle 122 may comprise two half shafts, for example first half shaft 122a, and second half shaft 122b. Vehicle propulsion system 100 further has front wheels 130 and rear wheels 131. Rear wheels 231 may be driven via electric machine 126.

The rear axle 122 is coupled to electric machine 126. Rear drive unit 136 may transfer power from electric machine 126 to axle 122 resulting in rotation of rear wheels 131. Rear drive unit 136 may include a low gear 175 and a high gear 177 that are coupled to electric machine 126 via rotor 126a of electric machine 126. Low gear 175 may be engaged via fully closing low gear clutch 176. High gear 177 may be engaged via fully closing high gear clutch 178. High gear clutch 178 and low gear clutch 176 may be opened and closed via commands received by rear drive unit 136 over controller area network (CAN) 199. Alternatively, high gear clutch 178 and low gear clutch 176 may be opened and closed via digital outputs or pulse widths provided via control system 114. Rear drive unit 136 may include differential 128 so that torque may be provided to first half shaft 122a and to second half shaft 122b. In some examples, an electrically controlled differential clutch (not shown) may be included in rear drive unit 136.

Electric machine 126 may receive electrical power from electric energy storage device 132. Furthermore, electric machine 126 may provide a generator function to convert the vehicle's kinetic energy into electrical energy, where the electrical energy may be stored at electric energy storage device 132 for later use by electric machine 126. An inverter system controller (ISC1) 134 may convert alternating current generated by electric machine 126 to direct current for storage at the electric energy storage device 132 and vice versa. Electric drive system 135 includes electric machine 126 and inverter system controller 134. Electric energy storage device 132 may be a battery, capacitor, inductor, or other electric energy storage device. Electric power flowing into electric drive system 135 may be monitored via current sensor 145 and voltage sensor 146. Position and speed of electric machine 126 may be monitored via position sensor 147 (e.g., a resolver or an encoder), which may be coupled to rotor 126a. Torque generated by electric machine 126 may be monitored via torque sensor 148.

In some examples, electric energy storage device 132 may be configured to store electrical energy that may be supplied to other electrical loads residing on-board the vehicle (other than the motor), including cabin heating and air conditioning, engine starting, headlights, cabin audio and video systems, etc.

Control system 114 may communicate with electric machine 126, electric energy storage device 132, etc. Control system 114 may receive sensory feedback information from electric drive system 135 and electric energy storage device 132, etc. Further, control system 114 may send control signals to electric drive system 135 and electric energy storage device 132, etc., responsive to this sensory feedback. Control system 114 may receive an indication of an operator requested output of the vehicle propulsion system from a human operator 102, or an autonomous controller. For example, control system 114 may receive sensory feedback from pedal position sensor 194 which communicates with pedal 192. Pedal 192 may refer schematically to a driver demand pedal. Similarly, control system 114 may receive an indication of an operator requested vehicle slowing via a human operator 102, or an autonomous controller. For example, control system 114 may receive sensory feedback from pedal position sensor 157 which communicates with vehicle slowing pedal 156.

Electric energy storage device 132 may periodically receive electrical energy from a power source such as a stationary power grid (not shown) residing external to the vehicle (e.g., not part of the vehicle). As a non-limiting example, vehicle propulsion system 100 may be configured as a plug-in electric vehicle (EV), whereby electrical energy may be supplied to electric energy storage device 132 via the power grid (not shown).

Electric energy storage device 132 includes an electric energy storage device controller 139 and a power distribution module 138. Electric energy storage device controller 139 may provide charge balancing between energy storage element (e.g., battery cells) and communication with other vehicle controllers (e.g., controller 112). Power distribution module 138 controls flow of power into and out of electric energy storage device 132.

One or more wheel speed sensors (WSS) 195 may be coupled to one or more wheels of vehicle propulsion system 100. The wheel speed sensors may detect rotational speed of each wheel. Such an example of a WSS may include a permanent magnet type of sensor.

Controller 112 may comprise a portion of a control system 114. In some examples, controller 112 may be a single controller of the vehicle. Control system 114 is shown receiving information from a plurality of sensors 116 (various examples of which are described herein) and sending control signals to a plurality of actuators 181 (various examples of which are described herein). As one example, sensors 116 may include tire pressure sensor(s) (not shown), wheel speed sensor(s) 195, etc. In some examples, sensors associated with electric machine 126, wheel speed sensor 195, etc., may communicate information to controller 112, regarding various states of electric machine operation. Controller 112 includes non-transitory (e.g., read exclusive memory) 165, random access memory 166, digital inputs/outputs 168, and a microcontroller 167. Controller 112 may receive input data and provide data to human/machine interface 140 via CAN 199.

The system of FIG. 1 provides for a system, comprising: an electric drive system including an electric machine; and one or more controllers including executable instructions stored in non-transitory memory that cause the one or more controllers to adjust an electric machine rotor position offset value in response to transitioning the electric drive system from a first group of operating conditions to a second group of operating conditions, the electric machine having greater losses at the second group of operating conditions than at the first second group of operating conditions. In a first example, the system further comprises additional executable instructions that cause the one or more controllers to adjust the electric machine rotor position offset value in response to transitioning the electric drive system from the second group of operating conditions to the first group of operating conditions. In a second example that may include the first example, the system includes where the transitioning from the first group of operating conditions to the second group of operating conditions includes increasing an electric machine flux current i_{d} and decreasing an electric machine torque current i_{q}. In a third example that may include one or both of the first and second examples, the system includes where the electric drive system also includes a resolver. In a fourth example that may include one or more of the first through third examples, the system further comprises additional instructions that cause the one or more controllers to adjust electric current supplied to the electric machine in response to the electric machine rotor position offset value. In a fifth example that may include one or more of the first through fourth examples, the system further comprises additional executable instructions that cause the one or more controllers to command the electric machine to a constant torque, the constant torque a driver demand torque. In a sixth example that may include one or more of the first through fifth examples, the system further comprises additional instructions that cause the one or more controllers to enter the second group of operating conditions in response to a request to heat a vehicle component.

The system of FIG. 1 provides for a system, comprising: an electric drive system including an electric machine; and one or more controllers including executable instructions stored in non-transitory memory that cause the one or more controllers to adjust an electric machine rotor position offset value in response to transitioning the electric drive system from a maximum torque per ampere (MTPA) mode to a lossy mode. In a first example, the system further comprises additional executable instructions that cause the one or more controllers to adjust the electric machine rotor position offset value in response to transitioning the electric drive system from the lossy mode to the MTPA mode. In a second example that may include the first example, the system includes where the transitioning from the MTPA mode to the lossy mode includes increasing an electric machine flux current i_{d} and decreasing an electric machine torque current i_{q}. In a third example that may include one or both of the first and second examples, the system includes where the electric drive system also includes a resolver. In a fourth example that may include one or more of the first through third examples, the system further comprises additional instructions that cause the one or more controllers to adjust electric current supplied to the electric machine in response to the electric machine rotor position offset value. In a fifth example that may include one or more of the first through fourth examples, the system further comprises additional executable instructions that cause the one or more controllers to command the electric machine to a constant torque, the constant torque a driver demand torque. In a sixth example that may include one or more of the first through fifth examples, the system further comprises additional instructions that cause the one or more controllers to enter the lossy mode in response to a request to heat a vehicle component.

Referring now to FIG. 2, a block diagram of a space vector pulse width modulation motor controller 200 with electric machine position compensation is shown. The space vector pulse width modulation motor controller 200 includes electric machine 126. In this example, electric machine 126 is a three phase electric machine that is supplied with electric power via power inverter system controller 134. The amounts of electric current that are supplied in each of the three phases is input to block 214 where Park and Clark transforms convert the electric currents from each of the three phases into a measured torque current i_{q} and a measured flux current i_{d}. The measured flux current i_{d} is subtracted from the commanded flux current i_{d} at junction 214 (e.g., summing junction). The measured torque current i_{q} is subtracted from the commanded torque current i_{q} at junction 202 (e.g., summing junction). An electric machine torque request is input to current reference generator 201 and current reference generator 201 decomposes the electric machine torque request and outputs a commanded flux current i_{d} and a commanded torque current i_{q} to generate the requested electric machine torque.

A torque current proportional/integral controller 204 receives a torque current error from junction 202 and outputs a torque voltage v_{q} command. Similarly, a flux current proportional/integral controller 216 receives a flux current error from junction 214 and outputs a flux voltage v_{d} command. At block 206, the torque voltage v_{q} command and the flux voltage command v_{d} are processed via an inverse Park transform into a torque voltage in a rotating reference frame v_{α} and a flux voltage in the rotating reference frame v_{β}. At block 210, the torque voltage in the rotating reference frame v_{α} and the flux voltage in the rotating reference frame v_{β} are converted into phase pulses via space vector pulse width modulation. The pulses operate the transistors or switches in the power inverter system controller 134. The power inverter system controller 134 includes an inverter that outputs voltages for each of the phase windings of electric machine 126. The rotor position of electric machine 126 may be sensed via position sensor 147 that outputs signals that are converted into an electric machine rotor position (e.g., an angle) via module 211 and the electric machine rotor position is supplied to summing junction 212 where a rotor position offset value may be added to the electric machine rotor position. Module 211 may be comprised of hardware and/or software that resides in one of the controllers mentioned in FIG. 1.

Referring now to FIG. 3, an example plot that illustrates a two different reference frames for an electric machine is shown. The first reference frame is a controller reference frame that includes a torque voltage v_{q}^{c} and a flux voltage v_{d}^{c} that may be combined to form a command voltage in the controller reference frame. The controller referenced torque voltage axis is indicated at 304 and it is a function of a position of a stator 308 of the electric machine. The controller referenced flux voltage axis is indicated at 306 and it is also a function of stator position. The second reference frame is a rotor reference frame that includes a torque voltage v_{q}^{r} and a flux voltage v_{d}^{r} that may be combined to form a command voltage in the rotor reference frame. The rotor torque voltage axis is indicated at 310 and it is a function of a position of rotor 126a which rotates within a stator (not shown). The rotor flux voltage axis is indicated at 312 and it is also a function of a position of rotor 126a. Rotor 126a includes permanent magnets 350.

Referring now to FIG. 4, a plot that illustrates a comparison between baseline electric machine operation and lossy mode operation is shown. Baseline electric machine operation may also be referred to as maximum torque per ampere (MTPA) operation where electric machine torque current i_{q} and electric machine flux current i_{d} generate maximum electric machine torque output for minimum electric current input to the electric machine. Lossy mode is an operating mode of the electric machine where electric machine losses (e.g., losses due to magnetic field changes, copper losses, etc. that result in electric machine heating) increase over baseline operating mode. Lossy mode may be described as operating the electric machine at a speed with losses that are greater than losses of operating the electric machine at the speed in baseline operating mode by more than baseline operating mode losses plus a pre-defined amount of loss (e.g., between 8 and 400 percent of baseline operating losses at a particular electric machine rotor speed), or baseline operating mode losses plus the specified additional losses for the electric machine at the given operating condition.

Plot 400 includes a vertical axis and a horizontal axis. The vertical axis represents electric machine torque current i_{q} and the horizontal axis represents electric machine flux current i_{d}. Plot 400 also includes lines 402-416 that represent constant torque output levels for the electric machine. The constant torque lines increase in torque from line 416 to line 402. Additionally, plot 400 includes line 404 which represents maximum torque per ampere electric machine operation.

Six different electric machine operating conditions are indicated as P₁-P₃ and P′₁-P′₃. P₁ represents electric machine operating conditions where the electric machine is operating in MTPA mode and on MTPA curve 404. Operating conditions at P′₁ are the same operating conditions as operating conditions at P₁, but operating conditions at P′₁ include a five electrical degree error. This error represents the effect of a five degree electric machine rotor position error and it causes electric machine torque at P′₁ to increase slightly from the electric machine torque at P₁, but the losses of the electric machine are greater at P′₁ than at P₁. P₂ represents electric machine operating conditions where the electric machine is operating in MTPA mode and on MTPA curve 412. Operating conditions at P′₂ are the same operating conditions as operating conditions at P₂, but operating conditions at P′₂ include a five electrical degree error. This error represents the effect of a five degree electric machine rotor position error and it causes electric machine torque at P′₂ to remain substantially equal to the electric machine torque at P₂, but the losses of the electric machine are greater at P′₂ than at P₂. P₃ represents electric machine operating conditions where the electric machine is operating in lossy mode away from curve 450 to generate the torque that is represented by line 412. The lossy mode may be entered when it may be desirable to warm the vehicle's traction battery, warm the vehicle's passenger cabin, or warm other vehicle components. Operating conditions at P′₃ are the same operating conditions as operating conditions at P₃, but operating conditions at P′₃ include a five electrical degree error. This error represents the effect of a five degree electric machine rotor position error when the electric machine is operating in lossy mode and it causes electric machine torque at P′₃ to increase an amount that may be more than may be desired. Thus, if the driver demand is constant and such that electric machine torque is equal to the torque represented at P₂, changing from operating the electric machine in MTPA mode to operating in lossy mode may cause a torque increase according to the torque difference between P′₂ and P′₃ when there is a 5 degree error in the electric machine's rotor position. This torque error may be reduced or eliminated by determining a more accurate electric machine rotor position estimate via the method of FIG. 5 or the method of FIG. 6.

Referring to FIG. 5, a flowchart of a method for estimating a position offset for an electric machine is shown. The method of FIG. 5 may be at least partially implemented as executable instructions stored in controller memory in the system of FIG. 1. Further, the method of FIG. 5 may include actions taken in the physical world to transform operating states of the system of FIG. 1. In addition, in some examples, the method of FIG. 5 may be distributed amongst several controllers where each controller performs a portion of the method.

At 502, method 500 monitors electric drive system operating conditions including but not limited to electric machine rotor position, electric machine current, and electric machine temperature. The electric machine rotor position may be monitored via a resolver or an encoder. Method 500 proceeds to 504.

At 504, method 500 commands and operates the electric machine in a maximum torque per ampere (MTPA) mode where the electric machine generates a maximum torque at the electric machine's present speed with a minimum amount of electric current flow into the electric machine. Thus, the electric machine may operate at a first group of highly efficient operating conditions. In one example, method 500 adjusts electric machine torque current i_{q} and electric machine flux current i_{d} to operate the electric machine in MTPA mode. The electric machine also operates in the MTPA to generate a requested driver demand torque. Method 500 proceeds to 506.

At 506, method 500 judges whether or not the electric machine has been requested to operate in lossy mode. The electric machine may be requested to operate in lossy mode to heat a vehicle component (e.g., passenger cabin, electric energy storage device, etc.) or to enter lossy mode as part of a resolver or position measuring device compensation or calibration procedure. If method 500 judges that the electric machine has been requested to operate in lossy mode, the answer is yes and method 500 proceeds to 508 to command the electric machine to operate in lossy mode. Otherwise, the answer is no and method 500 returns to 504.

At 508, method 500 commands and operates the electric machine at a constant torque. The constant torque may be equal to the driver demand torque. If the electric machine torque is following driver demand torque, the driver demand torque may be specified to be substantially constant (e.g., vary by less than 5% from a constant value). Further, the electric machine may operate at a constant or substantially constant (e.g., where the speed value varies by less than 5 percent from a constant value) rotational speed by applying a constant load to the electric machine. The vehicle may be moving or stopped while the electric machine is operating at constant torque. Method 500 proceeds to 510.

At 510, method 500 transitions to operating the electric machine in a lossy mode, which is a second group of operating conditions with electric machine losses that are greater than when the electric machine is operated with the first group of operating conditions. The lossy mode may be entered via commanding an increase of the electric machine flux current i_{d} and commanding a reduction of the electric machine torque current i_{q} to attempt to maintain the electric machine torque output while changing the electric machine from MTPA mode to lossy mode. Method 500 proceeds to 512.

At 512, method 500 judges whether or not an unexpected change in electric machine rotational speed occurs when the electric machine transitions from MTPA mode to lossy mode. In one example, the magnitude of an unexpected electric machine rotational speed may be based on operating conditions such as mass of the vehicle and its contents, engaged gear (e.g., 1^{st} gear or 2^{nd} gear), road grade, and vehicle operating mode (e.g., park, neutral, drive, etc.). For example, if a vehicle's transmission is engaged in park (e.g., the transmission's output shaft is locked from rotating via a parking pawl and each transmission clutch is held open), the unexpected change in electric machine rotational speed may be 30 revolutions/minute or greater. However, if the vehicle's transmission is engaged in drive and a load is applied to the electric machine, the unexpected change in electric machine rotational speed may be 20 revolutions/minute or greater. If method 500 judges that there is an unexpected change in electric machine rotational speed, the answer is yes and method 500 proceeds to 514. When there is an unexpected change in electric machine rotational speed, it may be inferred that there is an error in the sensing of electric motor rotor position since an error in electric motor position may result in a torque change as indicated at P′₃ as shown in FIG. 4. If method 500 judges that there is no unexpected change in electric machine rotor rotational speed, the answer is no and method 500 proceeds to 513.

At 513, method 500 maintains the present electric machine rotor position offset value. Method 500 proceeds to exit.

At 514, method 500 judges whether or not the unexpected change in electric machine speed is an increase in electric machine rotational speed. If so, the answer is yes and method 500 proceeds to 516. Otherwise, the answer is no and method 500 proceeds to 515.

At 515, method 500 adjusts an electric machine rotor position offset value so that torque current i_{q} increases to increase electric machine torque output in lossy mode. The electric rotor position offset value may be added to an electric machine rotor position value that is determined according to output of the electric machine rotor position sensor (e.g., resolver or encoder). In one example, the electric rotor position offset may be adjusted by a predetermined amount, one rotor angular degree for example. Method 500 proceeds to exit.

At 516, method 500 adjusts an electric machine rotor position offset value so that torque current i_{q} decreases to decrease electric machine torque output in lossy mode. The electric rotor position offset value may be added to an electric machine rotor position value that is determined according to output of the electric machine rotor position sensor (e.g., resolver or encoder). In one example, the electric rotor position offset may be adjusted by a predetermined amount. Method 500 proceeds to exit.

Thus, the method of FIG. 5 provides for adjusting the electric motor rotor position offset value when transitioning into lossy mode from MTPA mode. If lossy mode is entered while not maintaining electric machine speed, the electric motor rotor position offset may be adjusted. As such, the change in electric machine rotational speed may be indicative of an electric machine rotor position error when entering lossy mode from MTPA mode.

Referring to FIG. 6, a flowchart of a method for estimating a position offset for an electric machine is shown. The method of FIG. 6 may be at least partially implemented as executable instructions stored in controller memory in the system of FIG. 1. Further, the method of FIG. 6 may include actions taken in the physical world to transform operating states of the system of FIG. 1. In addition, in some examples, the method of FIG. 6 may be distributed amongst several controllers where each controller performs a portion of the method.

At 602, method 600 monitors electric drive system operating conditions including but not limited to electric machine rotor position, electric machine current, and electric machine temperature. The electric machine rotor position may be monitored via a resolver or an encoder. Method 600 proceeds to 604.

At 604, method 600 commands and operates the electric machine in lossy mode at a second group of operating conditions where the electric machine generates torque less efficiently as compared to when the electric machine is operating in MTPA mode for a given torque request. The electric machine generates the requested driver demand torque at the electric machine's present speed. In one example, method 600 adjusts electric machine torque current i_{q} and electric machine flux current i_{d} to operate the electric machine in lossy mode. For example, method 600 may increase electric machine flux current i_{d} in lossy mode as compared to when operating in MTPA mode. Method 600 proceeds to 606.

At 606, method 600 judges whether or not the electric machine has been requested to operate in MTPA mode. The electric machine may be requested to operate in MTPA mode to increase electric machine efficiency. If method 600 judges that the electric machine has been requested to operate in MTPA mode, the answer is yes and method 600 proceeds to 608. Otherwise, the answer is no and method 600 returns to 604.

At 608, method 600 commands and operates the electric machine at a constant torque. The constant torque may be equal to the driver demand torque. If the electric machine torque is following driver demand torque, the driver demand torque may be specified to be substantially constant (e.g., vary by less than 5% from a constant value). Further, the electric machine may operate at a constant or substantially constant (e.g., where the speed value varies by less than 5 percent from a constant value) rotational speed by applying a constant load to the electric machine. The vehicle may be moving or stopped while the electric machine is operating at constant torque. For example, the vehicle's transmission may be engaged in park via a parking pawl, neutral (e.g., each transmission clutch is held open), or drive (e.g., engaged in a forward gear). Method 600 proceeds to 610.

At 610, method 600 transitions to operating the electric machine in a MTPA mode, which operates the electric machine with a first group of operating conditions where the electric machine operates more efficiently with the first group of operating conditions as compared to when the electric machine is operated with the second group of operating conditions. The MTPA mode may be entered via commanding a decrease in the electric machine flux current i_{d} and an increase of the electric machine torque current i_{q} to attempt to maintain the electric machine torque output while changing the electric machine from lossy mode to MTPA mode. Method 600 proceeds to 612.

At 612, method 600 judges whether or not an unexpected change in electric machine rotational speed occurs when the electric machine transitions from lossy mode to MTPA mode. In one example, the magnitude of an unexpected electric machine rotational speed may be based on operating conditions such as mass of the vehicle and its contents, engaged gear (e.g., 1^{st} gear or 2^{nd} gear), road grade, and vehicle operating mode (e.g., park, drive, etc.). For example, if a vehicle's transmission is engaged in park, the unexpected change in electric machine rotational speed may be 30 revolutions/minute or greater. However, if the vehicle's transmission is engaged in drive and a load is applied to the electric machine, the unexpected change in electric machine rotational speed may be 20 revolutions/minute or greater. If method 600 judges that there is an unexpected change in electric machine rotational speed, the answer is yes and method 600 proceeds to 614. When there is an unexpected change in electric machine rotational speed, it may be inferred that there is an error in the sensing of electric motor rotor position since an error in electric motor position may result in a torque change as indicated at P′₃ as shown in FIG. 4. If method 600 judges that there is no unexpected change in electric machine rotor rotational speed, the answer is no and method 600 proceeds to 613.

At 613, method 600 maintains the present electric machine rotor position offset value. Method 600 proceeds to exit.

At 614, method 600 judges whether or not the unexpected change in electric machine speed is an increase in electric machine rotational speed. If so, the answer is yes and method 600 proceeds to 616. Otherwise, the answer is no and method 600 proceeds to 615.

At 615, method 600 adjusts an electric machine rotor position offset value so that torque current i_{q} increases to increase electric machine torque output in MPTA mode. The electric rotor position offset value may be added to an electric machine rotor position value that is determined according to output of the electric machine rotor position sensor (e.g., resolver or encoder). In one example, the electric rotor position offset may be adjusted by a predetermined amount, one rotor angular degree for example. Method 600 proceeds to exit.

At 616, method 600 adjusts an electric machine rotor position offset value so that torque current i_{q} decreases to decrease electric machine torque output in MPTA mode. The electric rotor position offset value may be added to an electric machine rotor position value that is determined according to output of the electric machine rotor position sensor (e.g., resolver or encoder). In one example, the electric rotor position offset may be adjusted by a predetermined amount. Method 600 proceeds to exit.

Thus, the method of FIG. 6 provides for adjusting the electric motor rotor position offset value when transitioning into MTPA mode from lossy mode. If MTPA mode is entered while not maintaining electric machine speed, the electric motor rotor position offset may be adjusted. As such, the change in electric machine rotational speed may be indicative of an electric machine rotor position error when entering MTPA mode from lossy mode.

The methods of FIGS. 5 and 6 provide for a method for operating an electric drive system, comprising: via a controller, operating an electric machine in a maximum torque per ampere (MTPA) operating mode; transitioning the electric machine to a lossy operating mode in response to a request to enter lossy operating mode; adjusting a rotor position offset value based on a change in a rotational speed of a rotor of the electric machine during transitioning the electric machine to the lossy operating mode; and adjusting current supplied to the electric machine in response to the rotor position offset. In a first example, the method includes where transitioning to the lossy operating mode includes increasing an electric machine flux current i_{d} and decreasing an electric machine torque current i_{q}. In a second example that may include the first example, the method includes where the electric machine includes permanent magnets. In a third example that may include one or both of the first and second examples, the method further comprises commanding the electric machine to a constant torque during transitioning the electric machine to the lossy operating mode. In a fourth example that may include one or more of the first through third examples, where the constant torque is a driver demand torque. In a fifth example that may include one or more of the first through fourth examples, the method further comprises adjusting the rotor position offset such that electric machine torque current i_{q} decreases in response to an increase in electric machine rotational speed during the transitioning the electric machine to the lossy operating mode. In a sixth example that may include one or more of the first through fifth examples, the method further comprises adjusting the rotor position offset such that electric machine torque current i_{q} increases in response to an decrease in electric machine rotational speed during the transitioning the electric machine to the lossy operating mode. In a seventh example that may include one or more of the first through sixth examples, the method further comprises operating the electric machine at a constant speed immediately before transitioning the electric machine to the lossy operating mode.

The methods of FIGS. 5 and 6 also provide for a method for operating an electric drive system, comprising: via a controller, operating an electric machine in a lossy operating mode; transitioning the electric machine to a maximum torque per ampere (MTPA) operating mode in response to a request to exit lossy operating mode; adjusting a rotor position offset value based on a change in a rotational speed of a rotor of the electric machine during transitioning the electric machine to the MTPA operating mode; and adjusting current supplied to the electric machine in response to the rotor position offset. In a first example, the method further comprises commanding the electric machine to a constant torque during transitioning the electric machine to the MTPA operating mode. In a second example that may include the first example, the method includes where the constant torque is a driver demand torque. In a third example that may include one or both of the first and the second example, the method includes where transitioning to the MTPA operating mode includes decreasing an electric machine flux current i_{d} and increasing an electric machine torque current i_{q}. In a fourth example that may include one or more of the first through third examples, the method further comprises adjusting the rotor position offset such that electric machine torque current i_{q} decreases in response to an increase in electric machine rotational speed during the transitioning the electric machine to the MTPA operating mode.

The methods of FIGS. 5 and 6 also provides for a method for operating an electric drive system, comprising: via a controller, operating an electric machine at a first group of conditions with a first amount of losses; transitioning the electric machine operating at a second group of conditions with a second amount of losses, the second amount of losses greater than the first amount of losses in response to a request to increase electric machine losses; adjusting a rotor position offset value based on a change in a rotational speed of a rotor of the electric machine during transitioning the electric machine from the first group of conditions to the second group of conditions; and adjusting current supplied to the electric machine in response to the rotor position offset value. In a first example, the method includes where transitioning to the second group of conditions includes increasing an electric machine flux current i_{d} and decreasing an electric machine torque current i_{q}. In a second example that may include the first example, the method includes where the electric machine includes permanent magnets. In a third example that may include one or both of the first and second examples, the method further comprises commanding the electric machine to a constant torque during transitioning the electric machine to the second group of conditions. In a fourth example that may include one or more of the first through third examples, the method includes where the constant torque is a driver demand torque. In a fifth example that may include one or more of the first through fourth examples, the method further comprises adjusting the rotor position offset value such that electric machine torque current i_{q} decreases in response to an increase in electric machine rotational speed during the transitioning the electric machine to the second group of conditions. In a sixth example that may include one or more of the first through fifth examples, the method further comprises adjusting the rotor position offset value such that electric machine torque current i_{q} increases in response to a decrease in electric machine rotational speed during the transitioning the electric machine to the second group of conditions. In a seventh example that may include one or more of the first through sixth examples, the method further comprises operating the electric machine at a constant speed immediately before transitioning the electric machine to the second group of conditions.

The methods of FIGS. 5 and 6 also provides for a method for operating an electric drive system, comprising: via a controller, operating an electric machine at a second group of operating conditions with a second amount of losses; transitioning the electric machine to operating the electric machine at a first group of operating conditions with a first amount of losses in response to a request to the second group of operating conditions, the second amount of losses greater than the first amount of losses; adjusting a rotor position offset value based on a change in a rotational speed of a rotor of the electric machine during transitioning the electric machine to the first group of operating conditions; and adjusting current supplied to the electric machine in response to the rotor position offset value. In a first example, the method further comprises commanding the electric machine to a constant torque during transitioning the electric machine to the first group of operating conditions. In a second example that may include the first example, the method includes where the constant torque is a driver demand torque. In a third example that may include one or both of the first and second examples, the method includes where transitioning to the first group of operating conditions includes decreasing an electric machine flux current i_{d} and increasing an electric machine torque current i_{q}. In a fourth example that may include one or more of the first through third examples, the method further comprises adjusting the rotor position offset value such that electric machine torque current i_{q} decreases in response to an increase in electric machine rotational speed during the transitioning the electric machine to the first group of operating conditions.

Note that the example control and estimation routines included herein can be used with various electric machine and/or vehicle system configurations. The control methods and routines disclosed herein may be stored as executable instructions in non-transitory memory and may be carried out by the control system including the controller in combination with the various sensors, actuators, and other electric machine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, at least a portion of the described actions, operations and/or functions may graphically represent code to be programmed into non-transitory memory of the computer readable storage medium in the control system. The control actions may also transform the operating state of one or more sensors or actuators in the physical world when the described actions are carried out by executing the instructions in a system including the various electric drive system hardware components in combination with one or more controllers.

This concludes the description. The reading of it by those skilled in the art would bring to mind many alterations and modifications without departing from the spirit and the scope of the description. For example, the present approach may be applied to induction machines, permanent magnet AC electric machines, and other electric machines that have sensors for determining rotor position could use the present description to advantage.

1. A system, comprising:
an electric drive system including an electric machine; and
one or more controllers including executable instructions stored in non-transitory memory that cause the one or more controllers to adjust an electric machine rotor position offset value in response to transitioning the electric drive system from a first group of operating conditions to a second group of operating conditions, the electric machine having greater losses at the second group of operating conditions than at the first second group of operating conditions.

2. The system of claim 1, further comprising additional executable instructions that cause the one or more controllers to adjust the electric machine rotor position offset value in response to transitioning the electric drive system from the second group of operating conditions to the first group of operating conditions.

3. The system of claim 1, where the transitioning from the first group of operating conditions to the second group of operating conditions includes increasing an electric machine flux current i_{d} and decreasing an electric machine torque current i_{q}.

4. The system of claim 1, where the electric drive system also includes a resolver.

5. The system of claim 1, further comprising additional instructions that cause the one or more controllers to adjust electric current supplied to the electric machine in response to the electric machine rotor position offset value.

6. The system of claim 1, further comprising additional executable instructions that cause the one or more controllers to command the electric machine to a constant torque, the constant torque a driver demand torque.

7. The system of claim 1, further comprising additional instructions that cause the one or more controllers to enter the second group of operating conditions in response to a request to heat a vehicle component.

8. A method for operating an electric drive system, comprising:
via a controller, operating an electric machine at a first group of conditions with a first amount of losses;
transitioning the electric machine to operating at a second group of conditions with a second amount of losses in response to a request to increase electric machine losses, the second amount of losses greater than the first amount of losses;
adjusting a rotor position offset value based on a change in a rotational speed of a rotor of the electric machine during transitioning the electric machine from the first group of conditions to the second group of conditions; and
adjusting current supplied to the electric machine in response to the rotor position offset value.

9. The method of claim 8, where transitioning to the second group of conditions includes increasing an electric machine flux current i_{d} and decreasing an electric machine torque current i_{q}.

10. The method of claim 8, where the electric machine includes permanent magnets.

11. The method of claim 8, further comprising commanding the electric machine to a constant torque during transitioning the electric machine to the second group of conditions.

12. The method of claim 11, where the constant torque is a driver demand torque.

13. The method of claim 8, further comprising adjusting the rotor position offset value such that electric machine torque current i_{q} decreases in response to an increase in electric machine rotational speed during the transitioning the electric machine to the second group of conditions.

14. The method of claim 8, further comprising adjusting the rotor position offset value such that electric machine torque current i_{q} increases in response to a decrease in electric machine rotational speed during the transitioning the electric machine to the second group of conditions.

15. The method of claim 8. further comprising operating the electric machine at a constant speed immediately before transitioning the electric machine to the second group of conditions.

16. A method for operating an electric drive system, comprising:
via a controller, operating an electric machine at a second group of operating conditions with a second amount of losses;
transitioning the electric machine to operating the electric machine at a first group of operating conditions with a first amount of losses in response to a request to the second group of operating conditions, the second amount of losses greater than the first amount of losses;
adjusting a rotor position offset value based on a change in a rotational speed of a rotor of the electric machine during transitioning the electric machine to the first group of operating conditions; and
adjusting current supplied to the electric machine in response to the rotor position offset value.

17. The method of claim 16, further comprising commanding the electric machine to a constant torque during transitioning the electric machine to the first group of operating conditions.

18. The method of claim 17, where the constant torque is a driver demand torque.

19. The method of claim 16, where transitioning to the first group of operating conditions includes decreasing an electric machine flux current i_{d} and increasing an electric machine torque current i_{q}.

20. The method of claim 16, further comprising adjusting the rotor position offset value such that electric machine torque current i_{q} decreases in response to an increase in electric machine rotational speed during the transitioning the electric machine to the first group of operating conditions.
